(19) United States
(12) Patent Application Publication
(10) Pub. No.: US 2016/0232871 A1
(43) Pub. Date: Aug. 11, 2016

(54) DISPLAY METHOD AND DISPLAY DEVICE

(71) Applicant: LE SHI ZHI XIN ELECTRONIC TECHNOLOGY (TIANJIN) LIMITED, Beijing (CN)

(72) Inventors: Mingyang ZHAO, Beijing (CN); Jiazi TIAN, Beijing (CN)

(21) Appl. No.: 15/023,671

(22) PCT Filed: Sep. 25, 2014
(86) PCT No.: PCT/CN2014/087435

§ 371 Date: Mar. 21, 2016

(30) Foreign Application Priority Data
Sep. 26, 2013 (CN) 201310447100.4

(51) Int. Cl. G09G 5/00

(52) U.S. Cl. CPC G09G 5/003; G09G 2370/20

(57) ABSTRACT

Disclosed are a display method and a display apparatus. The display method comprises: when a first data signal received by a current signal source port is displayed in a current preview window corresponding to the current signal source port, receiving a switching instruction from a control device, the switching instruction being used for indicating switching from the current signal source port to a first signal source port; according to the switching instruction, acquiring a second data signal received by the first signal source port; and displaying the second data signal at the position of the first preview window corresponding to the first signal source port. The display method and display apparatus of the present application can improve the display effect, facilitate the operation of a user, and improve the user experience.

### CROSS-REFERENCE

This application is based upon Chinese Patent Application 201310447100.4, titled “Display Method and Display Device”, filed on Sep. 26, 2013, the entire contents of which are incorporated herein by reference.

### TECHNICAL FIELD

The present application relates to the field of display technologies, and more particularly, to a display method and a display apparatus.

### BACKGROUND

With the wide application of intelligentized technologies, various household electrical appliances and communication products such as TV, mobile phone or the like, have been “intelligentized” increasingly. An intelligentized display device at present can display various signals since it has a plurality of signal source ports.

In the prior art, the display device can usually display a plurality of signal source ports to users in a display interface in the forms of signal source port names or signal source port icons, so that the users may select the signal source ports displayed in the display interface according to the needs thereof so as to switch the signal sources.

However, the foregoing method of displaying a plurality of signal source ports by the display method enables the users to achieve the object of switching the signal sources, but the signal sources are not sufficiently clear and intuitive. That is, the users need to know the effects of each signal source port and then can select a corresponding signal source port to switch the signal source, thereby affecting the display effects, not facilitating the user operation, and reducing the user experience.

### SUMMARY

The embodiments of the present application provide a display method and a display apparatus, which can improve the display effects, facilitate the user operation, and improve the user experience.

In order to fulfill the foregoing objects, the embodiments of the present application employ the following technical solutions.

According to a first aspect, there is provided a display method, including: when displaying a first data signal received by a current signal source port in a current preview window corresponding to the current signal source port, receiving a switching instruction from a control device, the switching instruction being used to instruct to switch from the current signal source port to a first signal source port; acquiring a second data signal received by the first signal source port according to the switching instruction; and displaying the second data signal in the position of a first preview window corresponding to the first signal source port.

Further, acquiring the second data signal received by the first signal source port according to the switching instruction further includes: configuring a first player and a first graphic program interface corresponding to the first signal source port to play the second data signal.

Further, configuring the first player and the first graphic program interface corresponding to the first signal source port further includes: creating the first player and the first graphic program interface corresponding to the first signal source port, and associating the first player with the first graphic program interface so as to display a playing image of the first player through the first graphic program interface.

Further, configuring the first player and the first graphic program interface corresponding to the first signal source port further includes: logging off a current player and a current graphic program interface corresponding to the current signal source port, and releasing resources occupied by the current player and the current graphic program interface so as to use the resources when creating the first player and the first graphic program interface corresponding to the first signal source port.

Further, configuring the first player and the first graphic program interface corresponding to the first signal source port further includes: reading locally pre-stored position data and dimension data in the attribute information of the first preview window, setting the first graphic program interface corresponding to the first signal source port in the position of the first preview window, and controlling the dimension of the playing image of the first player corresponding to the first signal source port to be matched with the dimension of the first preview window through the first graphic program interface.

Further, configuring the first player and the first graphic program interface corresponding to the first signal source port further includes: parsing to obtain audio and video parameters of the second data signal, and configuring the first player corresponding to the first signal source port according to the audio and video parameters of the second data signal.

Further, the displaying of the second data signal in the position of the first preview window corresponding to the first signal source port includes: inputting the second data signal to the first player corresponding to the first signal source port to play; and displaying the playing image of the first player in the first preview window through the first graphic program interface corresponding to the first signal source port.

Further, the method, after displaying the second data signal in the position of the first preview window corresponding to the first signal source port, further includes: receiving a full screen playing instruction from the control device, calling in a full screen dimension, and controlling to amplify the dimension of the playing image of the first player to be matched with the full screen dimension through the first graphic program interface.

Further, the method, after displaying the second data signal in the position of the first preview window corresponding to the first signal source port, further includes: when receiving the switching instruction from the control device, intercepting the last frame static image of the first data signal received by the current signal source port, and displaying the last frame static image of the first data signal in the current preview window.

According to a second aspect, there is provided a display method, including: presetting a plurality of preview windows on a desktop, each preview window corresponding to one signal source port; and receiving an enabled instruction from a control device, respectively acquiring a data signal received by each signal source port, and displaying the data signal received by the corresponding signal source port in each preview window.

Further, the method, after receiving the enabled instruction from the control device, and respectively acquiring the data signals received by each signal source port, further includes: configuring a player and a graphic program interface corresponding to each signal source port so as to play the data signal received by each signal source port.

Further, the configuring the player and the graphic program interface corresponding to each signal source port further includes: creating a player and a graphic program interface corresponding to each signal source port, and associating the player and the graphic program interface corresponding to the same signal source port, so as to display a playing image of the player corresponding to the same signal source port through the graphic program interface corresponding to the same signal source port.

Further, the configuring the player and the graphic program interface corresponding to each signal source port includes: reading locally pre-stored position data and dimension data in the attribute information of each preview window; and for the player, the graphic program interface and the preview window corresponding to the same signal source port, setting the graphic program interface in the position of the corresponding preview window, and controlling the dimension of the playing image of the player to be matched with the dimension of the preview window through the graphic program interface.

Further, configuring the player and the graphic program interface corresponding to each signal source port includes: parsing to acquire audio and video parameters of a data signal received by each signal source port, and configuring the player corresponding to each signal source port according to the audio and video parameters of the data signal received by each signal source port.

Further, displaying the data signal received by the corresponding signal source port in each preview window further includes: inputting the data signal received by each signal source port to the player corresponding to each signal source port to play; and displaying the playing image of the corresponding player in each preview window through the graphic program interface corresponding to the corresponding signal source port.

Further, the method, after displaying the data signal received by the corresponding signal source port in each preview window further includes: receiving a triggering instruction from the control device for the signal source port, keeping receiving the data signal of the triggered signal source port, and calling in a full screen dimension; controlling to amplify the dimension of a playing image of the player of the triggered signal source port to be matched with the full screen dimension through the graphic program interface of the triggered signal source port; and logging off a player and a graphic program interface corresponding to an untriggered signal source port to release the occupied resources.

According to a third aspect, there is provided a display apparatus, comprising: a processor; and

an memory for storing commands executed by the processor; wherein the processor is configured to: when displaying a first data signal received by a current signal source port in a current preview window corresponding to the current signal source port, receiving a switching instruction from a control device, the switching instruction being used to instruct to switch from the current signal source port to a first signal source port; acquiring a second data signal received by the first signal source port according to the switching instruction; and displaying the second data signal in the position of a first preview window corresponding to the first signal source port.

Compared with the existing solution, the present application achieves the technical effects that:

according to the display method and the display apparatus provided by the embodiments of the present application, data/analog signals received by the switched signal source port may be displayed in a preview manner, or the data/analog signals received by various signal source ports can be displayed in a preview manner at the same time.

### BRIEF DESCRIPTION OF THE DRAWINGS

FIG. 1 is a flow chart of a display method provided by the first embodiment of the present application;

FIG. 2 is a flow chart of another display method provided by the second embodiment of the present application;

FIG. 3 is a flow chart of a display method provided by a third embodiment of the present application;

FIG. 4 is a flow chart of another display method provided by a fourth embodiment of the present application;

FIG. 5 is a structure diagram of a display device provided by a fifth embodiment of the present application;

FIG. 6 is another structure diagram of the display device provided by the fifth embodiment of the present application;

FIG. 7 is a structure diagram of a display device provided by a sixth embodiment of the present application;

FIG. 8 is another structure diagram of the display device provided by the sixth embodiment of the present application;

FIG. 9 is another structure diagram of the display device provided by the sixth embodiment of the present application;

FIG. 10 is a structure diagram of a display device provided by a seventh embodiment of the present application; and

FIG. 11 is a structure diagram of a display device provided by an eighth embodiment of the present application.

FIG. 12 is a structure diagram of a display apparatus provided by an ninth embodiment of the present application.

FIG. 13 is a structure diagram of a display apparatus provided by an tenth embodiment of the present application.

### PREFERRED EMBODIMENTS

The implementation manners of the present application will be explained in details with reference to the drawings and embodiments hereinafter, so that the realization process of how to solve the technical problems using a technical means and achieve the technical efficacy can be sufficiently understood and implemented accordingly.

### First Embodiment

The embodiment of the present application provides a display method. As shown in FIG. 1, the method may include the following steps.

In S101, when the display device displays a first data signal received by a current signal source port in a current preview window corresponding to the current signal source port, the display device receives a switching instruction from a control device, the switching instruction being used to instruct to switch from the current signal source port to a first signal source port.

The signal source refers to an instrument or device that outputs the data signal. If the display device is externally connected to the signal source, then the data signal outputted by the signal source may be inputted into the display device and displayed, so that a user may view the data signal outputted by the signal source. The port refers to an interface for the device to be communicated with the outside. The signal source port refers to an interface which is in the display device and is connected to an external signal source. In the embodiment of the present application, a plurality of signal source ports may be set in the display device, so that the user may select a signal source port so as to select a signal source connected to the signal source port.

It should be illustrated that the external signal source of the display device provided by the embodiment of the present application may include: a set-top box, a USB (Universal Serial Bus, universal serial bus), a DVD (Digital Versatile Disc, digital versatile disc), a mobile phone, a computer and the like. Accordingly, the signal source port of the display device may include a CVBS (Composite Video Broadcast Signal) port, a left channel port, a right channel port, a USB port, a HDMI (High Definition Multimedia Interface), a VGA (Video Graphics Array) port and the like. Wherein, the CVBS port may be used to transmit a composite video signal, the left channel port may be used to transmit a compressed low-level audio signal related to simulating left human ear, the right channel port may be used to transmit a compressed low-level audio signal related to simulating right human ear, the USB port may be used to transmit a signal in a USB device, the HDMI may be used to transit all-digital audio signal and video signal without compression, and the VGA port may be used to transmit a simulated video signal.

When the user needs to know the data signals outputted by various signal sources, the user may switch each signal source port and view a displaying image corresponding to each signal source port to know the data signals outputted by each signal source connected to each signal source port. When the display device displays the first data signal received by the current signal source port in the current preview window corresponding to a current signal source port, the user switches the signal source through the control device, i.e., the display device receives the switching instruction given by the control device, the switching instruction being used to instruct to switch from the current signal source port to the first signal source port, wherein the current signal source port may be any port in the foregoing signal source ports of the display device, and the first signal source port may be any port in the foregoing signal source ports of the display device excluding the current signal source port.

For example, the foregoing control device may either be a remote controller, or the display device itself. On one hand, if the control device is a remote controller, then after the user uses the remote controller to launch a signal source desktop of the display device, provided that the signal source connected to the current signal source port HDMI is a set-top box, when the user uses the direction keys of the remote controller like “up”, “down”, “left” and “right” to select a VGA port, or uses the direction keys to select the VGA port in combination with pressing a confirm key of the remote controller, the signal source port of the display device is switched from the current signal source port HDMI to the VGA port (i.e., the first signal source port) selected by the user at the current moment; meanwhile, the signal source of the display device is also switched from the set-top box to a computer connected to the VGA port. On the other hand, if the foregoing control device is the display device itself, i.e., the user may complete the switching between the foregoing signal source ports through the keys configured on the display device; to be specific, the switching process is similar to the process of the user to switch using a remote controller, and will not be elaborated herein.

It is to be understood that when the user switches the current signal source port to the first signal source port on the signal source desktop, the signal source connected to the current signal source port is also switched to the signal source connected to the first signal source port.

In S102, the display device acquires a second data signal received by the first signal source port according to the switching instruction.

When the user switches the signal source through the control device, the display device after receiving the switching instruction sent by the control device, acquires the second data signal received by the first signal source port according to the switching instruction, i.e., the second data signal outputted by the signal source connected to the first signal source port.

For example, when the user uses the keys set on the remote controller or on the display device to switch the signal source port of the display device from HDMI to VGA port, the display device may acquire the second data signal from a computer connected to the VGA port from the VGA port of the display device.

It should be illustrated that the switching instruction refers to a signal emitted by the remote controller or the display device and capable of driving a remote-controlled circuit on a motherboard of the display device after the user selects a certain signal source port and presses the confirm key of the remote controller or the confirm key of the display device.

On the other hand, the switching instruction may also refer to a signal emitted by the remote controller, a somatosensory device or the display device and capable of driving the remote-controlled circuit on the motherboard of the display device according to a focal point moving operation in the process of the user moving a focal point to the corresponding signal source port through such manners as operation through the direction keys, cursor moving operation or gesture operation.

Optionally, the foregoing second data signal may include an audio signal, a video signal or the like.

In S103, the display device displays the second data signal in the position of a first preview window corresponding to the first signal source port.

It should be illustrated that when designing the display device, a designer may provide a preview image of the signal source desktop of the display device, and the preview image provides position data of various preview windows respectively corresponding to various signal source ports; when a developer develops the display device, the position data of various preview windows respectively corresponding to various signal source ports can be stored in the display device.

Optionally, the foregoing position data may be a coordinate position of the preview window corresponding to each signal source port on the display interface, i.e., forming an X-coordinate and a Y-coordinate of each top point of the preview window in the display interface.

After the display device acquires the second data signal received by the first signal source port, the display device may display the second data signal received by the first signal source port in the first preview window according to the position data of the first preview window corresponding to the first signal source port stored in the display device, and the user can know the data signal outputted by the signal source connected to the signal source port through viewing the contents played by the preview window corresponding to a certain signal source port, thus previewing the second data signal outputted by the signal source connected to the first signal source port, and facilitating the user to intuitively and clearly select the signal source which needs to view thereof.

For example, when the user uses the keys arranged on the remote controller or the display device to switch the signal source port of the display device from a signal source port connected to the set-top box to a signal source port connected to the computer, the display device may acquire the second data signal that is from the computer and received by the signal source port from the signal source port connected to the computer, and the display device may display the second data signal from the computer in the preview window according to the locally stored position data of the preview window corresponding to the signal source port connected to the computer.

According to the display method provided by the embodiment of the present application, when the user switches a signal source, the display device may display the second data signal received by the switched signal source port in the preview window corresponding to the signal source port, which namely displays the second data signal received by the switched signal source port in a preview manner; therefore, the user can intuitively and clearly know the second data signal received by the signal source port which is namely the second data signal outputted by the signal source connected to the signal source port, thus being capable of improving the display effect, facilitating the user operation and improving the user experience.

### Second Embodiment

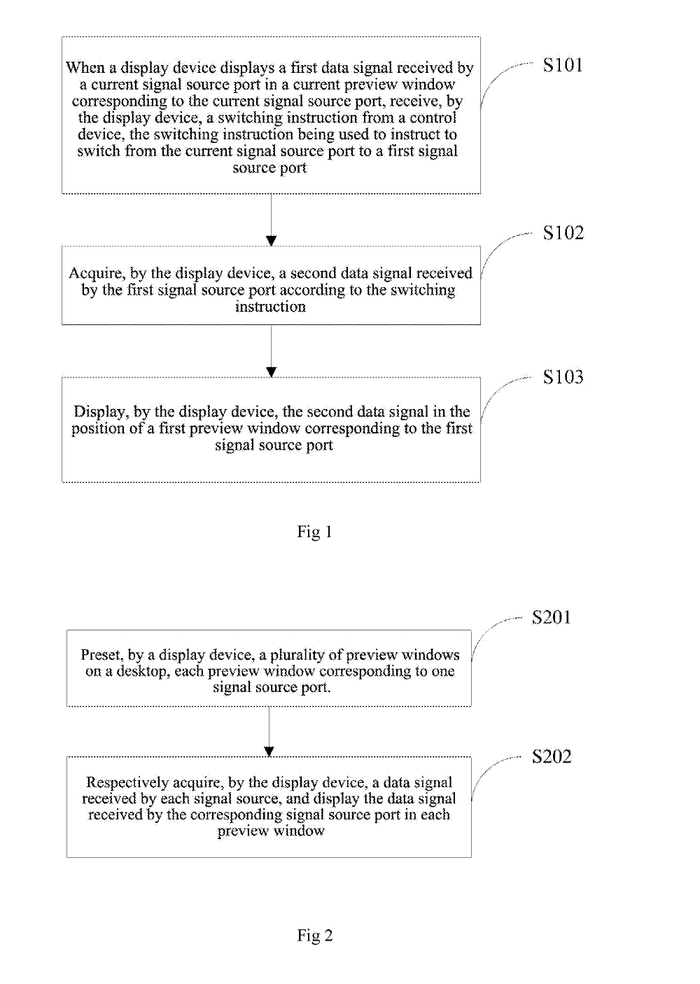

The embodiment of the present application also provides another display method. As shown in FIG. 2, the method may include the following steps.

In S201, the display device presets a plurality of preview windows on a desktop, each preview window corresponding to one signal source port.

For example, in the embodiment of the present application, four types of desktops like a CATV desktop, a video carousel desktop, a smart application desktop and a signal source desktop are arranged in the display device, and the desktop in step S201 namely refers to the signal source desktop. It should be illustrated that when designing the display device, a designer will provide a preview image of the signal source desktop of the display device, a plurality of preview windows are arranged in the preview image, and each window may be used for displaying the data of one signal source port. The preview image provides position data of various preview windows respectively corresponding to various signal source ports; when a developer develops the display device, the position data of various preview window respectively corresponding to various signal source ports may be stored in the display device. Optionally, the foregoing position data may be a coordinate position of the preview window corresponding to various signal source ports in the display interface.

The signal source refers to an instrument or device that outputs the data signal. If the display device is externally connected to the signal source, then the data signal outputted by the signal source may be inputted into the display device and displayed, so that a user may view the data signal outputted by the signal source. The port refers to an interface for the device to be communicated with the outside. The signal source port refers to an interface which is in the display device and is connected to an external signal source. In the embodiment of the present application, a plurality of signal source ports may be arranged in the display device, so that the user may select a signal source port so as to select a signal source connected to the signal source port.

In S202, the display device respectively acquires a data signal received by each signal source, and displays the data signal received by the corresponding signal source port in each preview window.

The display device after respectively acquiring the data signal received by each signal source port, may display the data signal received by various signal source ports in various corresponding preview windows according to the position data of various preview windows which are stored by the display device and respectively corresponding to various signal source ports, thus previewing the data signals outputted by the signal sources connected to each signal source port at the same time, and facilitating the user to intuitively and clearly select the signal source which needs to view thereof.

It should be illustrated that the display device needs to call in related interfaces provided by a base hardware platform of the display device to respectively acquire data signals from the corresponding signal sources connected to each signal source port. Optionally, the foregoing data signal may include an audio signal, a video signal or the like.

In the embodiment of the present application, because the base hardware platform of the display device can play multipass signals at the same time, the display method provided by the embodiment of the present application may support to play the data outputted by various signal sources in various preview windows at the same time, wherein the base hardware platform of the display device refers to a software architecture and a hardware system capable of driving each chip on a motherboard of the display device to run so as to implement the functions thereof. To be specific, the multipass playing function of the base hardware platform of the display device depends on a multipass function configured on a main control chip on the motherboard of the display device, i.e., the main control chip on the motherboard of the display device provided by the embodiment of the present application may be configured with a multipass playing function, so that the base hardware platform of the display device may drive the main control chip on the motherboard of the display device to implement the multipass playing function.

According to the another display method provided by the embodiment of the present application, when the user enables a signal source desktop, the data signals received by each signal source port of the display device may be displayed in each preview window respectively corresponding to each signal source port at the same time, i.e., the data signals received by various signal source ports are displayed in a preview manner at the same time; therefore, the user can intuitively and clearly know the data signals received by each signal source port, thus being capable of improving the display effect, facilitating the user operation and improving the user experience.

### Third Embodiment

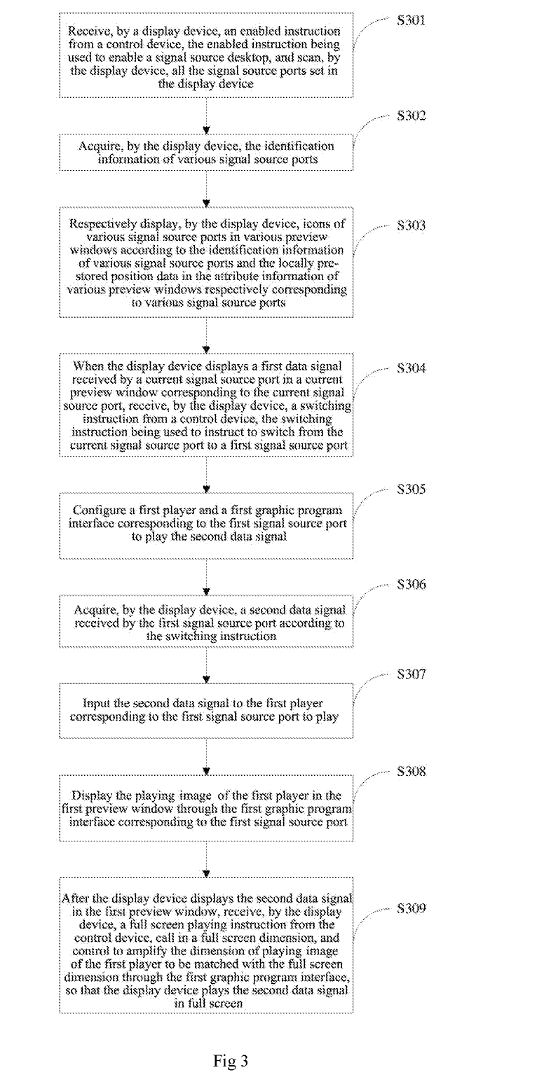

The embodiment of the present application provides a display method. As shown in FIG. 3, the method may include the following steps.

In S301, the display device receives an enabled instruction from a control device, the enabled instruction being used to enable a signal source desktop, and the display device scans all the signal source ports arranged in the display device.

The signal source refers to an instrument or device that outputs the data signal. If the display device is externally connected to the signal source, then the data signal outputted by the signal source may be inputted into the display device and displayed, so that a user may view the data signal outputted by the signal source. The port refers to an interface for the device to be communicated with the outside. The signal source port refers to an interface which is in the display device and is connected to an external signal source. In the embodiment of the present application, a plurality of signal source ports may be arranged in the display device, so that the user may select a signal source port so as to select a signal source connected to the signal source port.

It should be illustrated that the external signal source of the display device provided by the embodiment of the present application may include: a set-top box, a USB, a DVD, a mobile phone, a computer and the like. Accordingly, the signal source port of the display device may include a CVBS port, a left channel port, a right channel port, a USB port, a HDMI, a VGA port and the like. Wherein, the CVBS port may be used to transmit a composite video signal, the left channel port may be used to transmit a compressed low-level audio signal related to simulating left human ear, the right channel port may be used to transmit a compressed low-level audio signal related to simulating right human ear, the USB port may be used to transmit a signal in a USB device, the HDMI may be used to transit all-digital audio signal and video signal without compression, and the VGA port may be used to transmit a simulated video signal.

For example, in the embodiment of the present application, four types of desktops like a CATV desktop, a video carousel desktop, a smart application desktop and a signal source desktop are arranged in the display device; that is, after the display device is enabled, the display device can display the four types of desktops, so that the user may select a corresponding desktop to view corresponding programs according to the demand thereof. The user may switch the four types of desktops by using direction keys arranged in the remote controller or the display device, so as to implement the quick switching among a CATV station, network live video, application software and an external signal source.

It should be illustrated that the CATV desktop refers to a display interface on the display device for receiving a CATV signal from the set-top box; the video carousel desktop refers to a display interface for network live video; the smart application desktop refers to a display interface on the display device for loading application software; and the signal source desktop refers to a display interface of a signal source port set on the display device and capable of being connected to an external signal source.

In the embodiment of the present application, a plurality of signal source ports may be set in the display device; when the user needs to switch the signal source ports, the user may use the control device to make the display device enable the signal source desktop, and in the process of the display device enabling the signal source desktop, all the signal source ports for use in the display device can be scanned.

It is to be understood that all the signal source ports in the display device refer to all ports capable of being connected to external signal sources set in the display device, wherein the signal source ports may include HDMI, VGA, USB and the like. The signal source port in the display device is set on the motherboard of the display device, wherein the motherboard of the display device refers to a main circuit board installed in the display device, which mainly includes a circuit unit and a main control chip of the display device for implementing various functions, while the main control chip is a core component of the motherboard of the display device, and can be used to connect to various circuit units on the motherboard of the display device, and the main control chip implements corresponding functions through controlling various circuit units, so as to control the entire display device to implement corresponding functions. Particularly, the implementation of the functions of each signal source port on the motherboard of the display device needs to be controlled by the main control chip on the motherboard of the display device.

Optionally, the foregoing control device may either be a remote controller, or the display device itself. On one hand, if the control device is a remote controller, then the user may use the keys of the remote controller to give an enabled instruction to the display device, while the display device may enable the signal source desktop of the display device according to the enabled instruction. On the other hand, if the foregoing control device is the display device itself, then the user may give an enabled instruction through the keys arranged on the display device to enable the foregoing signal source desktop. A specific process for enabling the signal source desktop is similar to the process of enabling the signal source desktop through the remote-operated controller, and will not be elaborated herein.

To be specific, if the user uses the remote controller to enable the signal source desktop, then the user may use a signal source key on the remote controller to send an enabled instruction to the display device, so that the display device may enable the signal source desktop of the display device according to the enabled instruction. If the user uses the keys arranged on the display device to enable the signal source desktop, then the user may use the signal source key on the display device to send an enabled instruction to the display device, so that the display device enables the signal source desktop according to the enabled instruction, wherein the foregoing enabled instruction may be a signal capable of driving a remote-controlled circuit on the motherboard of the display device which is sent by pressing the signal source key on the remote controller or the signal source key on the display device by the user.

In S302, the display device acquires the identification information of each signal source port.

When the display device enables the signal source desktop, the display device can scan all usable signal source ports set in the display device, and respectively acquire the identification information of each signal source port, and store the identification information of each signal source port in the memory of the display device so as to provide basis for the user to preview the signal source subsequently.

It should be illustrated that the identification information of the signal source port may include the type of the signal source port. Optionally, the type of the signal source port may include CVBS, HDMI, VGA and the like.

In S303, the display device respectively displays an icon of each signal source port in each preview window according to the identification information of each signal source port and the locally pre-stored position data in the attribute information of each preview window respectively corresponding to each signal source port.

When the user enables the signal source desktop to preview the signal source through the display device, the display device may select the icon corresponding to each signal source port from a locally stored icon library of the signal source port according to the identification information of each signal source port, and display the icons of each signal source in each preview window respectively corresponding to each signal source port on the signal source desktop according to the locally stored position data of each preview window respectively corresponding to each signal source port. When the display device is externally connected to a signal source, the user may select the icon of the signal source port on the signal source desktop through the control device so as to preview the data signal received by the signal source port, thus acquiring the data signal outputted by the external signal source.

To be specific, during the developing process of the display device, a developer may store the position data of each preview window respectively corresponding to each signal source port in the display device; when the user enables the signal source desktop to preview the signal source through the display device, the display device respectively displays the icon of each signal source port in the center of each preview window corresponding to each signal source port by calling in the position data of each preview window.

It should be illustrated that the icon of the signal source port is provided by the designer and may be stored in the memory of the display device by the developer during the developing process, and the icon of a certain signal source port may be represented as the type of the signal source port. Further, the number of the preview windows corresponding to the signal source port and provided by the designer should be consistent with the number of the signal source ports set in the display device.

For example, if the signal source port is a VGA port, then the icon of the VGA port may be represented as a computer icon; if the signal source port is HDMI, then the icon of the HDMI may be represented as an HDMI typeface, and the like.

In S304, when the display device displays a first data signal received by a current signal source port in a current preview window corresponding to the current signal source port, the display device receives a switching instruction from a control device, the switching instruction being used to instruct to switch from the current signal source port to a first signal source port.

When the display device is externally connected to a plurality of signal sources, and when the user needs to know the data signals outputted by various signal sources, the user may select icons of various signal source ports and view displaying images corresponding to various signal source ports to know the data signals outputted by various signal sources connected to various signal source ports. When the display device is displaying the first data signal received by the current signal source port in the current preview window corresponding to a current signal source port, the user switches the signal source through the control device, i.e., the display device receives the switching instruction sent by the control device, the switching instruction being used to instruct to switch from the current signal source port to the first signal source port, wherein the current signal source port may be any port in the foregoing signal source ports of the display device, and the first signal source port may be any port in the foregoing signal source ports of the display device excluding the current signal source port.

For example, if the control device is a remote controller, then after the user uses the remote controller to launch a signal source desktop of the display device, provided that the signal source connected to the current signal source port HDMI is a set-top box, when the user uses the direction keys of the remote controller like “up”, “down”, “left” and “right” to select a VGA port, or uses the direction keys to select the VGA port in combination with pressing a confirm key of the remote controller, the signal source port of the display device is switched from the current signal source port HDMI to the VGA port (i.e., the first signal source port) selected by the user at the current moment; meanwhile, the signal source of the display device is also switched from the set-top box to a computer connected to the VGA port. On the other hand, if the foregoing control device is the display device itself, i.e., the user may complete the switching between the foregoing signal source ports through the keys set on the display device; to be specific, the switching process is similar to the process of the user to switch using a remote controller, and will not be elaborated herein.

It is to be understood that when the user switches the current signal source port to the first signal source port on the signal source desktop, the signal source connected to the current signal source port is also switched to the signal source connected to the first signal source port.

In S305, a first player and a first graphic program interface corresponding to the first signal source port are configured to play the second data signal.

The configuring contents mainly include the two aspects.

1) The player and the graphic program interface are created.

The received second data signal cannot be directly displayed, and can be parsed and played by defining a corresponding player. Meanwhile, the contents parsed and played need to be displayed on a screen through the graphic program interface.

Firstly, the first player and the first graphic program interface corresponding to the first signal source port are created, and the first player is associated with the first graphic program interface; in this way, a playing image of the first player can be displayed through the first graphic program interface.

Moreover, it should be illustrated that after the display device receives the switching instruction transmitted by the control device, the display device may know that the user needs to switch from the current signal source port to the first signal source port according to the switching instruction. Because a base hardware platform of the display device can only play the data signal of one external signal source at the same moment, in order to successfully play the second data signal received by the first signal source port, a current player and a current graphic program interface corresponding to the current signal source port may also be logged off to release resources occupied by the current player and the current graphic program interface before creating the first player and the first graphic program interface; in this way, the resources are used when creating the first player and the first graphic program interface corresponding to the first signal source port. Certainly, the current player and the current graphic program interface may not be logged off if the resources are sufficient, and the present application is not limited to this.

Finally, it also needs to parse and acquire audio and video parameters of the second data signal, and configure the first player corresponding to the first signal source port according to the audio and video parameters of the second data signal. It should be illustrated that here the audio and video parameters of the second data signal are not certainly acquired when receiving the second data signal; because the second data signal is from the first signal source port, the second data signal transmitted by the first signal source port is required to comply with the data standard of the first signal source port, and the data standard is known and determined, the audio and video parameters of the second data signal can be acquired according to the data standard. Certainly, the audio and video parameters of the second data signal may also be acquired by parsing the actually received second data signal according to the present application, and the audio and video parameters acquired in this way have stronger reliability.

Optionally, the audio and video parameters of the second data signal may include sampling frequency, amplitude, phase, signal-to-noise ratio or the like of an audio signal. The video parameters of the second data signal may include frame frequency, horizontal frequency, field frequency, image aspect ratio, analog encoding chromatism and the like of a video signal.

2) The graphic program interface is associated with a preview window.

Certainly, it is inadequate to have the player and the graphic program interface, and it is also desirable to define the display position of the first graphic program interface on the screen. In the solution of the present application, the display position is displayed in the first preview window.

All the attribute information of all the preview windows including the first preview window is defined on the signal source desktop in advance, including the position data, dimension data or the like of each preview window, wherein all these attribute information is pre-stored in the display device locally.

The locally pre-stored position data and dimension data in the attribute information of the first preview window are read. The first graphic program interface corresponding to the first signal source port is set in the position of the first preview window. And the dimension of the playing image of the first player corresponding to the first signal source port is controlled to be matched with the dimension of the first preview window through the first graphic program interface.

In the embodiment of the present application, the display device uses an Android system, wherein Android is an operating system based on a Linux (an operating system) open source code. The display device uses SurfaceView provided in an Android system to implement the graphic program interface in the solution of the present application. SurfaceView is a view technology for outputting and displaying images on an Android system platform, and it is able to implement the smooth moving and zooming features of the images, and make the output positions of the images be translated and scaled up/down by performing translation and zooming on the position of SurfaceView.

In S306, the display device acquires a second data signal received by the first signal source port according to the switching instruction.

When the user switches the signal sources through the control device, the display device firstly receives the switching instruction sent by the control device; after receiving the switching instruction, the display device may acquire the second data signal received by the first signal source port (i.e., the second data signal outputted by the signal source connected to the first signal source port) according to the switching instruction.

For example, when the user uses the keys on the remote controller or on the display device to switch the signal source port of the display device from HDMI to VGA port, the display device may acquire the second data signal from a computer connected to the VGA port from the VGA port of the display device.

It should be illustrated that when switching between the signal source ports, the display device needs to call in related interface provided by the base hardware platform of the display device to switch the first data signal acquired from the signal source connected to the current signal source port to the second data signal acquired from the signal source connected to the first signal source port.

It should be illustrated that the switching instruction refers to a signal emitted by the remote controller or the display device and capable of driving a remote-controlled circuit on a motherboard of the display device after the user selects a certain signal source port and presses the confirm key of the remote controller or the confirm key of the display device.

On the other hand, the switching instruction may also refer to a signal emitted by the remote controller, a somatosensory device or the display device and capable of driving the remote-controlled circuit on the motherboard of the display device according to a focal point moving operation in the process of the user moving a focal point to the corresponding signal source port through such manners as operation through the direction keys, cursor moving operation or gesture operation.

Optionally, the foregoing first data signal and the second data signal may include an audio signal, a video signal or the like.

It should be illustrated that after the display device receives the switching instruction from the control device, the execution sequence of S305 and S306 are not limited in the present application; that is, the present application may either perform step S305 and then perform S306; or perform S306 and then perform S305; and may also perform S305 and S306 at the same time.

In S307, the second data signal is inputted to the first player corresponding to the first signal source port to play.

After the display device acquires the parameters of the second data signal received by the first signal source port, and creates the first player corresponding to the first signal source port, the display device may configure the first player according to the parameters of the second data signal, and input the second data signal into the configured first player, so that the configured first player plays the second data signal.

For example, it is provided that the user uses the keys on the remote controller or the display device to switch the signal source port of the display device from HDMI switch to VGA port, the display device may acquire a signal source connected to the VGA port from the VGA port, such as the second data signal of a computer, and acquire the parameters of the second data signal according to the second data signal, such as the video parameter of the second data signal outputted by the computer, and the display device may configure the first player according to the parameters of the second data signal, so that the configured first player can play data signals whose types are consistent with the type of the second data signal received by the VGA port, and the display device can input the second data signal outputted by the computer and received by the VGA port to the configured first player, so that the configured first player can successfully play the second data signal.

It is to be understood that because the player needs to play the data signals consistent with the type of the second data signal received by the signal source port, different players need to be created for different signal source ports.

In S308, the playing image of the first player is displayed in the first preview window through the first graphic program interface corresponding to the first signal source port.

After the display device creates the first player and the first graphic program interface corresponding to the first signal source port, the display device has already set the first graphic program interface in the position of the first preview window. The user knows the data signal outputted by the signal source connected to the signal source port through viewing the contents played by a preview window corresponding to a certain signal source port.

Particularly, in order to enable the user to still acquire the first data signal received by the current signal source port before switching directly, when previewing the second data signal received by the switched first signal source port, the display device may intercept the last frame static image of the first data signal received by the current signal source port when receiving the switching instruction from the control device, and display the last frame static image of the first data signal in the current preview window when displaying the second data signal received by the first signal source port in the first preview window. In this way, the user is facilitated to select the programs needed thereof more intuitively. Wherein, the current signal source port refers to a signal source port selected by the user before the display device receives the switching instruction from the control device.

Optionally, if the base hardware platform of the display device can implement to play multipass signals at the same time, then the display method provided by the embodiment of the present application can support to play the data outputted by a plurality of signal sources in a plurality of preview windows at the same time, wherein the base hardware platform of the display device refers to a software architecture and a hardware system capable of driving each chip on the motherboard of the display device to implement the functions thereof. To be specific, the multipass playing function of the base hardware platform of the display device depends on the multipass function configured on the main control chip on the motherboard of the display device; if the main control chip on the motherboard of the display device is configured with the multipass playing function, then the base hardware platform of the display device can drive the main control chip on the motherboard of the display device to implement the multipass playing function.

In S309, after the display device displays the second data signal in the first preview window, the display device receives a full screen playing instruction from the control device, calls in a full screen dimension, and controls to amplify the playing image of the first player to be matched with the full screen dimension through the first graphic program interface, so that the display device plays the second data signal in full screen.

The full screen playing instruction in the step refers to a signal emitted by the remote controller, a somatosensory device or the display device and capable of driving the remote-controlled circuit on the motherboard of the display device according to a clicking and confirming operation in the selected preview window after moving a focal point in the corresponding preview window through such manners as operation through the direction keys, cursor moving operation or gesture operation.

Optionally, the implementation of the display method provided by the embodiment of the present application needs to be combined with the base hardware platform of the display device. If the base hardware platform of the display device is different, then the switching method of the signal source port may be possibly different as well; and the graphic program interface for outputting and displaying the images in the display device may either be a SurfaceView technology or a VideoView technology or a OpenGL (Open Graphics Library) during actual implementation, and will not be limited in the present application. Wherein, VideoView is used for playing video files, and it is able to read images from different resources (for example, resource file or content provider), calculate and maintain the picture dimension of the video so that the video is applied to an organizer in any configuration, and provide some display options like zooming, coloring and the like. OpenGL is a professional graphic program interface crossing programming languages and platforms, and can be used for calling in a base graphics library.

According to the display method provided by the embodiment of the present application, when the user switches a signal source, the display device may display the second data signal received by the switched signal source port in the preview window corresponding to the signal source port, which namely displays the second data signal received by the switched signal source port in a preview manner; therefore, the user can intuitively and clearly know the second data signal received by the signal source port which is namely the second data signal outputted by the signal source connected to the signal source port, thus being capable of improving the display effect, facilitating the user operation and improving the user experience.

### Fourth Embodiment

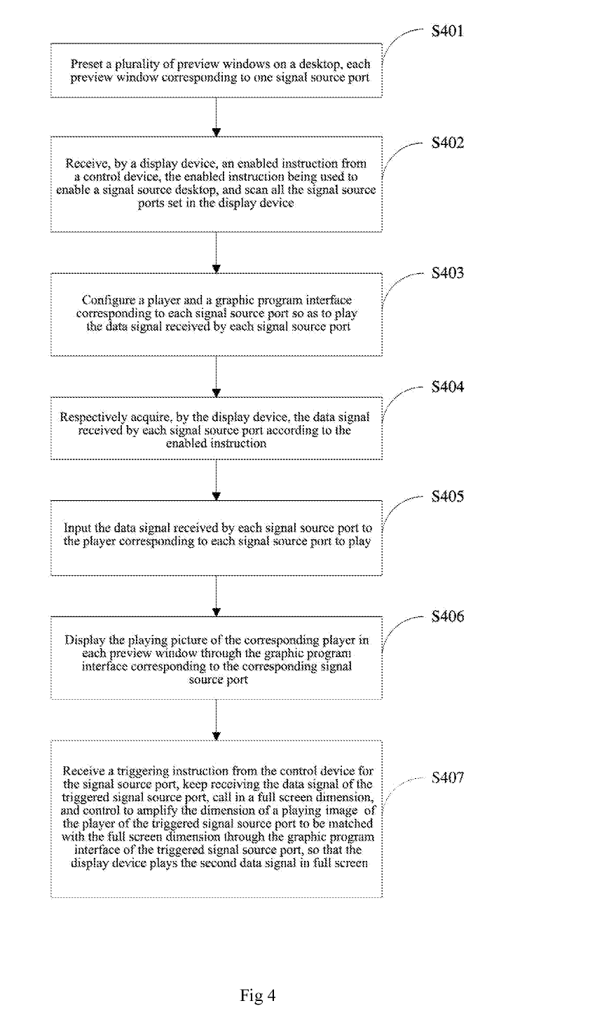

The embodiment of the present application also provides another display method. As shown in FIG. 4, the method may include the following steps.

In S401, a plurality of preview windows are preset on a desktop, each preview window corresponding to one signal source port.

For example, in the embodiment of the present application, four types of desktops like a CATV desktop, a video carousel desktop, a smart application desktop and a signal source desktop are arranged in the display device, and the desktop in step S401 namely refers to the signal source desktop. It should be illustrated that when designing the display device, a designer will provide a preview image of the signal source desktop of the display device, a plurality of preview windows are arranged in the preview image, and each window may be used for displaying the data of one signal source port. The preview image provides position data of various preview windows respectively corresponding to various signal source ports; when a developer develops the display device, the position data of various preview window respectively corresponding to various signal source ports may be stored in the display device. Optionally, the foregoing position data may be a coordinate position of the preview window corresponding to various signal source ports in the display interface, i.e., forming an X-coordinate and a Y-coordinate of each top point of the preview window in the display interface.

The signal source refers to an instrument or device that outputs the data signal. If the display device is externally connected to the signal source, then the data signal outputted by the signal source may be inputted into the display device and displayed, so that a user may view the data signal outputted by the signal source. The port refers to an interface for the device to be communicated with the outside. The signal source port refers to an interface which is in the display device and is connected to an external signal source. In the embodiment of the present application, a plurality of signal source ports may be set in the display device, so that the user may select a signal source port so as to select a signal source connected to the signal source port.

In S402, the display device receives an enabled instruction from a control device, the enabled instruction being used to enable a signal source desktop, and the display device scans all the signal source ports set in the display device.

For example, after the display device is enabled, four types of desktops like a CATV desktop, a video carousel desktop, a smart application desktop and a signal source desktop may be displayed in the display device, so that the user may select a corresponding desktop to view corresponding programs according to the demand thereof. The user may switch the four types of desktops by using direction keys arranged in a remote controller or the display device, so as to implement quick switching among a CATV station, network live video, application software and an external signal source.

In the embodiment of the present application, a plurality of signal source ports may be arranged in the display device; when the user needs to switch the signal source ports, the user may use the control device to make the display device enable the signal source desktop, and in the process of the display device enabling the signal source desktop, all the signal source ports for use in the display device can be scanned.

Optionally, the foregoing control device may either be the remote controller, or the display device itself. On one hand, if the control device is a remote controller, then the user may use the keys of the remote controller to send an enabled instruction to the display device, and the display device may enable the signal source desktop of the display device according to the enabled instruction. On the other hand, if the foregoing control device is the display device itself, then the user may give an enabled instruction through the keys arranged on the display device to enable the foregoing signal source desktop. A specific process for enabling the signal source desktop is similar to the process of enabling the signal source desktop through the remote-operated controller, and will not be elaborated herein.

In S403, a player and a graphic program interface corresponding to each signal source port are configured so as to play the data signal received by each signal source port.

The configuring contents mainly include the two aspects.

1) The player and the graphic program interface are created.

The data signal received by each signal source port cannot be directly displayed, and the data signal can be parsed and played by defining a corresponding player. Meanwhile, the contents parsed and played need to be displayed on a screen through the graphic program interface.

Firstly, a player and a graphic program interface corresponding to each signal source port are created, and the player and the graphic program interface corresponding to the same signal source port are associated, so as to display a playing image of the player corresponding to the same signal source port through the graphic program interface corresponding to the signal source port.

Moreover, the audio and video parameters of a data signal received by each signal source port are acquired by parsing, and the player corresponding to each signal source port is configured according to the audio and video parameters of the data signal received by each signal source port. It should be illustrated that here the audio and video parameters of the data signal are not certainly acquired when receiving the data signal received by each signal source port; because the data signal is from each signal source port, the data signal transmitted by each signal source port is required to comply with the data standard of the corresponding signal source port, while the data standard is known and determined, the audio and video parameters of the data signal of each signal source port can be acquired according to the data standard of each signal source port. Certainly, the audio and video parameters of the data signal may also be acquired by parsing the actually received data signal of each signal source port according to the present application, and the audio and video parameters acquired in this way have stronger reliability.

Optionally, the audio and video parameters of the data signal may include sampling frequency, amplitude, phase, signal to noise ratio or the like in audio signals. The video parameters of the data signal may include frame frequency, horizontal frequency, field frequency, image aspect ratio, simulated encoding chromatism and the like of a video signal.

2) The graphic program interface is associated with a preview window.

Certainly, it is inadequate to have the player and the graphic program interface, and it is also desirable to define the display position of the first graphic program interface on the screen. In the solution of the present application, all the attribute information of all the preview windows is defined on the signal source desktop in advance, including the position data, dimension data or the like of each preview window, wherein all these attribute information is also pre-stored in the display device locally. It is desirable to associate the corresponding graphic program interface with respective preview window.

Locally pre-stored position data and dimension data in the attribute information of each preview window is read. For the player, the graphic program interface and the preview window corresponding to the same signal source port, the graphic program interface is set in the position of the corresponding preview window, and the dimension of the playing image of the player is controlled to be matched with the preview window through the graphic program interface.

In the embodiment of the present application, the display device uses an Android system, wherein Android is an operating system based on a Linux (an operating system) open source code. The display device uses SurfaceView provided in an Android system to implement the graphic program interface in the solution of the present application. SurfaceView is a view technology for outputting and displaying images on an Android system platform, and it is able to implement the smooth moving and zooming features of the images, and make the output positions of the images be translated and scaled up/down by performing translation and zooming on the position of SurfaceView.

In S404, the display device respectively acquires the data signal received by each signal source port according to the enabled instruction.

When enabling the signal source desktop, the display device needs to call in related interfaces provided by a base hardware platform of the display device to respectively acquire data signals from the corresponding signal sources connected to each signal source port. Optionally, the foregoing data signal may include an audio signal, a video signal or the like.

It should be illustrated that the display device receives the switching instruction from the control device, the execution sequences of S403 and 5404 are not limited in the present application; that is, the present application may either perform step S403 and then perform S404; or perform S404 and then perform S403; and may also perform S403 and 5404 at the same time.

In S405, the data signal received by each signal source port is inputted to the player corresponding to each signal source port to play.

It should be illustrated that the display device needs to call in related interfaces provided by a base hardware platform of the display device to respectively acquire data signals from the corresponding signal sources connected to each signal source port. Optionally, the foregoing data signal may include an audio signal, a video signal or the like.

For example, it is provided that the user uses the keys on the remote controller or the display device to switch the signal source port of the display device from HDMI switch to VGA port, the display device may acquire a signal source connected to the VGA port from the VGA port, such as the second data signal of a computer, and acquire the parameters of the second data signal according to the second data signal, such as the video parameter of the second data signal outputted by the computer, and the display device may configure the first player according to the parameters of the second data signal, so that the configured first player can play data signals whose types are consistent with the type of the second data signal received by the VGA port, and the display device can input the second data signal outputted by the computer and received by the VGA port to the configured first player, so that the configured first player can successfully play the second data signal.

It is to be understood that because the player needs to play the data signals consistent with the type of the data signal received by the signal source port, different players need to be created for different signal source ports.

In S406, the playing image of the corresponding player is displayed in each preview window through the graphic program interface corresponding to the corresponding signal source port.

After the display device acquired the data signal received by each signal source port respectively, it may display the data signal received by each signal source port in each corresponding preview window at the same time according to the position data of each preview window which is stored by the display device and respectively corresponding to each signal source port, so as to preview the data signals outputted by the signal sources connected to each signal source port at the same time, and facilitate the user to intuitively and clearly select the signal source which needs to view thereof.

Optionally, if the base hardware platform of the display device can implement to play multipass signals at the same time, then it becomes a basis in the scheme of the present application supporting to play the data outputted by a plurality of signal sources in a plurality of preview windows at the same time, wherein the base hardware platform of the display device refers to a software architecture and a hardware system capable of driving each chip on the motherboard of the display device to implement the functions thereof. To be specific, the multipass playing function of the base hardware platform of the display device depends on the multipass function configured on the main control chip on the motherboard of the display device; if the main control chip on the motherboard of the display device is configured with the multipass playing function, then the base hardware platform of the display device can drive the main control chip on the motherboard of the display device to implement the multipass playing function.

In S407, a triggering instruction from the control device for the signal source port is received, the data signal of the triggered signal source port is kept being received, a full screen dimension is called in, and the dimension of a playing image of the player of the triggered signal source port is controlled to be amplified to be matched with the full screen dimension through the graphic program interface of the triggered signal source port, so that the display device plays the second data signal in full screen.

Moreover, because the data signal of the signal source port selected by the user through the control device is played in full screen at the moment, the data signal does not need to be displayed in other preview windows; accordingly, the corresponding player and graphic program interface are not required; at this moment, the player and the graphic program interface corresponding to the untriggered signal source port can be completely logged off so as to release the resources occupied. Certainly, the player and the graphic program interface corresponding to the untriggered signal source port may not be logged off either, and the present application is not limited to this.

Optionally, the implementation of the display method provided by the embodiment of the present application needs to be combined with the base hardware platform of the display device.

If the base hardware platform of the display device is different, then the switching method of the signal source port may be possibly different as well; and the graphic program interface for outputting and displaying the images in the display device may either be a SurfaceView technology or a VideoView technology or a OpenGL (Open Graphics Library, open graphics library) during actual implementation, and will not be limited in the present application.

Wherein, VideoView is used for playing video files, and it is able to read images from different resources (for example, resource file or content provider), calculate and maintain the picture dimension of the video so that the video is applied to an organizer in any configuration, and provide some display options like zooming, coloring and the like. OpenGL is a professional graphic program interface crossing programming languages and platforms, and it can be used for calling in a base graphics library.

According to the another display method provided by the embodiment of the present application, when the user enables a signal source desktop, the data signals received by each signal source port of the display device may be displayed in each preview window respectively corresponding to each signal source port at the same time, i.e., the data signals received by each signal source port are displayed in a preview manner at the same time; therefore, the user can intuitively and clearly know the data signals received by each signal source port, thus being capable of improving the display effect, facilitating the user operation and improving the user experience.

### Fifth Embodiment

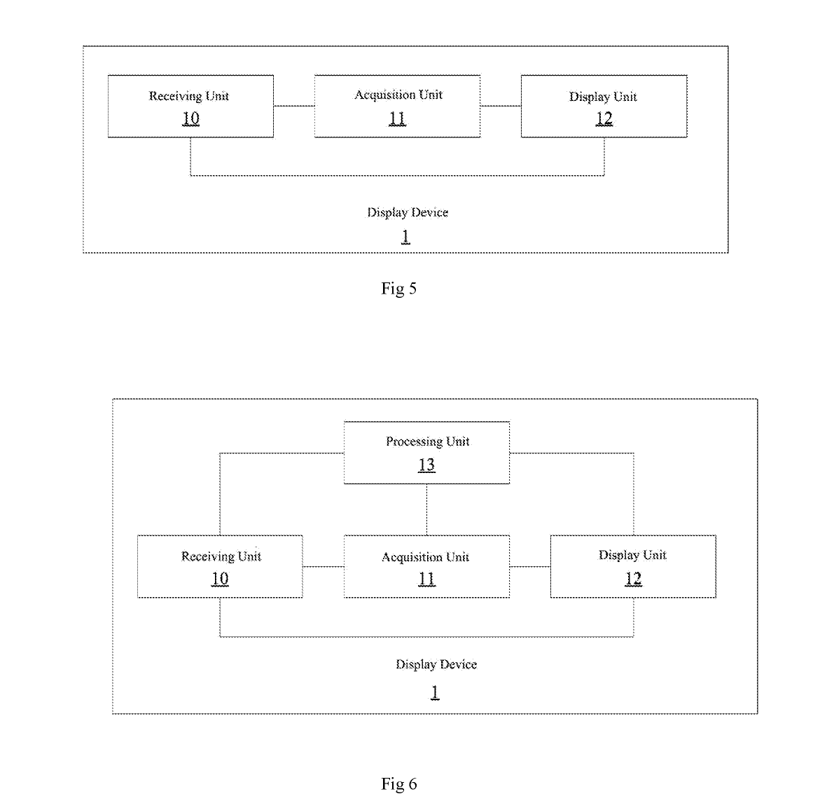

As shown in FIG. 5, the embodiment of the present application provides a display device 1 which corresponds to the display method provided by the first and third embodiments of the present application, wherein the display device 1 may include: a receiving module 10, an acquisition module 11 and a display module 12.

The receiving module 10 is used to, when the display module 12 displays a first data signal received by a current signal source port in a current preview window corresponding to the current signal source port, receive a switching instruction from a control device. The switching instruction is used to instruct to switch from the current signal source port to a first signal source port;

the acquisition module 11 is used to acquire a second data signal received by the first signal source port according to the switching instruction; and

the display module 12 is used to display the second data signal in the position of a first preview window corresponding to the first signal source port.

Optionally, as shown in FIG. 6, the display device further includes a processing module 13.

The processing module 13 is used to configure a first player and a first graphic program interface corresponding to the first signal source port to play the second data signal according to the switching instruction.

To be specific, the processing module 13 may be used to create the first player and the first graphic program interface corresponding to the first signal source port, and associate the first player with the first graphic program interface so as to display a playing image of the first player through the first graphic program interface; and/or,

the processing module 13 may be used to read locally pre-stored position data and dimension data in the attribute information of the first preview window, set the first graphic program interface corresponding to the first signal source port in the position of the first preview window, and control the dimension of the playing image of the first player corresponding to the first signal source port to be matched with the dimension of the first preview window through the first graphic program interface; and/or,

the processing module 13 may be used to parse to acquire audio and video parameters of the second data signal, and configure the first player corresponding to the first signal source port according to the audio and video parameters of the second data signal; and/or,

the processing module 13 may be used to log off a current player and a current graphic program interface corresponding to the current signal source port, and release resources occupied by the current player and the current graphic program interface so as to use the resources when creating the first player and the first graphic program interface corresponding to the first signal source port.

Moreover, optionally, the processing module 13 may also be used to input the second data signal to the first player corresponding to the first signal source port to play; and the display module 12 is used to display the playing image of the first player in the first preview window through the first graphic program interface corresponding to the first signal source port.

The receiving module 11 is used to receive a full screen display instruction from the control device; and the processing module 13 is also used to call in a full screen dimension, control to amplify the dimension of the playing image of the first player to be matched with the full screen dimension through the first graphic program interface, and notify the display module 12 to display.

The processing module 13 is also used to, when receiving the switching instruction from the control device, intercept the last frame static image of the first data signal received by the current signal source port; and the display module 12 is used to display the last frame static image of the first data signal in the current preview window.

According to the display device provided by the embodiment of the present application, when the user switches a signal source, the display device may display the second data signal received by the switched signal source port in the preview window corresponding to the signal source port, which namely displays the second data signal received by the switched signal source port in a preview manner; therefore, the user can intuitively and clearly acquire the second data signal received by the signal source port which is namely the second data signal outputted by the signal source connected to the signal source port, thus being capable of improving the display effect, facilitating the user operation and improving the user experience.

### Sixth Embodiment

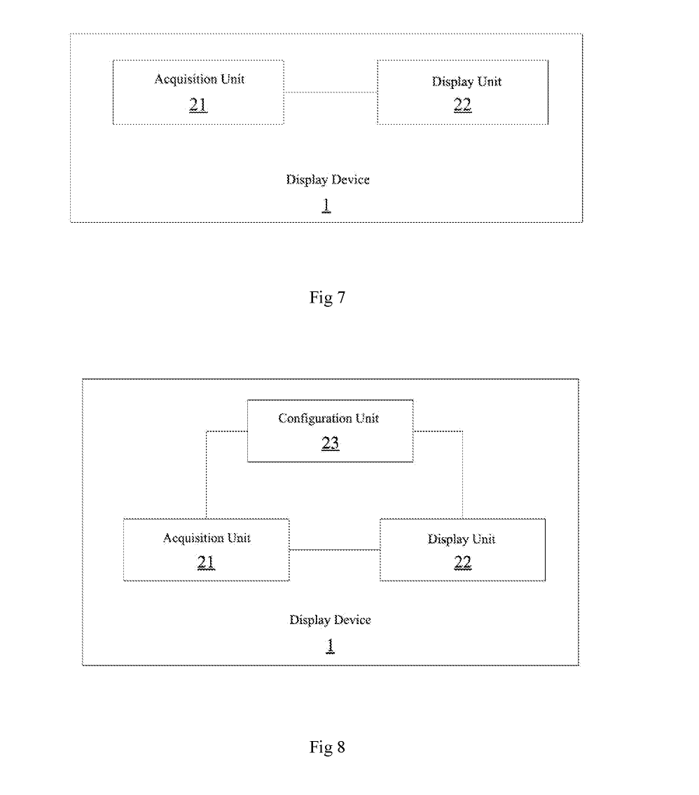

As shown in FIG. 7, the embodiment of the present application also provides a display device 1 which corresponds to another display method provided by the second and fourth embodiments of the present application, wherein the display device 1 may include: an acquisition module 21 and a display module 22.

The acquisition module 21 is used to respectively acquire a data signal received by each signal source port.

The display module 22 is used to preset a plurality of preview windows on a desktop, each preview window corresponding to one signal source port, and display the data signal received by the corresponding signal source port in each preview window through the acquisition module.

Moreover, optionally, the acquisition module 21 is used to input the data signal received by each signal source port to the player corresponding to each signal source port to play; and the display module 22 is used to display the playing image of the corresponding player in each preview window through the graphic program interface corresponding to the corresponding signal source port.

Optionally, as shown in FIG. 8, the display device further includes a configuration module 23.

The configuration module 23 is used to configure a player and a graphic program interface corresponding to each signal source port so as to play the data signal received by each signal source port.

To be specific, the configuration module 23 is further used to create a player and a graphic program interface corresponding to each signal source port, and associate the player and the graphic program interface corresponding to the same signal source port, so as to display a playing image of the player corresponding to the same signal source port through the graphic program interface corresponding to the same signal source port; and/or, the configuration module 23 is further used to read locally pre-stored position data and dimension data in the attribute information of each preview window; and for the player, the graphic program interface and the preview window corresponding to the same signal source port, set the graphic program interface in the position of the corresponding preview window, and control the dimension of the playing image of the player to be matched with the dimension of the preview window through the graphic program interface; and/or, the configuration module 23 is further used to acquire audio and video parameters of a data signal received by each signal source port, and configure the player corresponding to each signal source port according to the audio and video parameters of the data signal received by each signal source port.

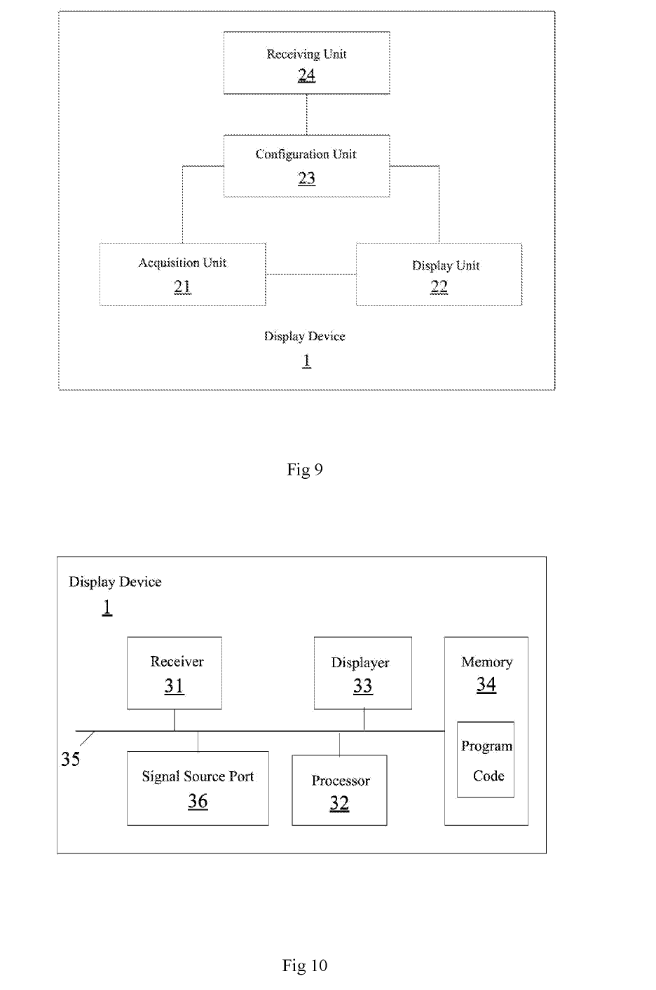

Optionally, as shown in FIG. 9, the display device further includes a configuration module 23 and a receiving module 24.

The receiving module 24 is used to receive a triggering instruction from the control device for the signal source port; and

the configuration module 23 is used to, when the receiving module 24 receives the triggering instruction, keep receiving the data signal of the triggered signal source port, and call in a full screen dimension, control to amplify the dimension of a playing image of the player of the triggered signal source port to be matched with the full screen dimension through the graphic program interface of the triggered signal source port; and log off a player and a graphic program interface corresponding to an untriggered signal source port to release the occupied resources.

According to the display device provided by the embodiment of the present application, when the user enables a signal source desktop, the data signals received by each signal source port of the display device may be displayed in each preview window respectively corresponding to each signal source port at the same time, i.e., the data signals received by each signal source port are displayed in a preview manner at the same time; therefore, the user can intuitively and clearly know the data signals received by each signal source port, thus being capable of improving the display effect, facilitating the user operation and improving the user experience.

### Seventh Embodiment

As shown in FIG. 10, the embodiment of the present application provides a display device which corresponds to the display method provided by the first and third embodiments of the present application, wherein the display device 1 may include a receiver 31, a processor 32, a display 33, a memory 34, a system bus 35 and a signal source port 36, wherein:

the receiver 31, the processor 32, the display 33, the memory 34 and the signal source port 36 are connected through the system bus 35 and the mutual communications are completed.

The processor 32 may be a single-core or multi-core central processing module, or a specific integrated circuit, or be configured into one or more integrated circuits that implement the embodiment of the present application.

The memory 34 may be a high speed RAM, or a non-volatile memory, for example, at least one magnetic disc memory.

The memory 34 is used for a computer executable instruction. To be specific, the computer executable instruction may include a program code.

To be specific, the receiver 31 may be used to, when the display 33 displays a first data signal received by a current signal source port in a current preview window corresponding to the current signal source port, receive a switching instruction from a control device, the switching instruction being used to instruct to switch from the current signal source port to the first signal source port 36; the processor 32 may acquire a second data signal received by the first signal source port 36 through the system bus 35 according to the switching instruction received by the receiver 31; the display 33 may be used to display the second data signal in the position of a first preview window corresponding to the first signal source port through the system bus 35; and the memory 34 may be used to store the software code of the second data signal received by the signal source port 36 and software program controlling the display device to complete the foregoing process, so that the processor 32 may complete the foregoing process through executing the software program stored in the memory 34 and calling in the corresponding software code.

Optionally, the processor 32 is used to configure a first player and a first graphic program interface corresponding to the first signal source port to play the second data signal.

Optionally, the processor 32 is used to, after the receiver 31 receives the switching instruction from the control device, create a first player and a first graphic program interface corresponding to the first signal source port 36, and associate the first player with the first graphic program interface so as to display the playing image of the first player through the first graphic program interface.

Optionally, the processor 32 is used to read locally pre-stored position data and dimension data in the attribute information of the first preview window, set the first graphic program interface corresponding to the first signal source port in the position of the first preview window, and control the dimension of the playing image of the first player corresponding to the first signal source port to be matched with the dimension of the first preview window.

Optionally, the processor 32 is used to parse to acquire audio and video parameters of the second data signal, and configure the first player corresponding to the first signal source port according to the audio and video parameters of the second data signal.

Optionally, the processor 32 is also used to log off a current player and a current graphic program interface corresponding to the current signal source port, and release resources occupied by the current player and the current graphic program interface so as to use the resources when creating the first player and the first graphic program interface corresponding to the first signal source port.

The processor 32 is also used to input the second data signal to the first player corresponding to the first signal source port to play; and the display 33 is used to display the playing image of the first player in the first preview window through the first graphic program interface corresponding to the first signal source port.

The receiver 31 is also used to receive a full screen display instruction from the control device; and the processor 32 is also used to call in a full screen dimension, and control to amplify the dimension of the playing image of the first player to be matched with the full screen dimension through the first graphic program interface.

The processor 32 is also used to, when receiving the switching instruction from the control device, intercept the last frame static image of the first data signal received by the current signal source port; and the display 33 is used to display the last frame static image of the first data signal in the current preview window.

The display device provided by the embodiment of the present application may be such a device as a smart TV, a computer, or the like.

According to the display device provided by the embodiment of the present application, when the user switches a signal source, the display device may display the second data signal received by the switched signal source port in the preview window corresponding to the signal source port, which namely displays the second data signal received by the switched signal source port in a preview manner; therefore, the user can intuitively and clearly acquire the second data signal received by the signal source port which is namely the second data signal outputted by the signal source connected to the signal source port, thus being capable of improving the display effect, facilitating the user operation and improving the user experience.

### Eighth Embodiment

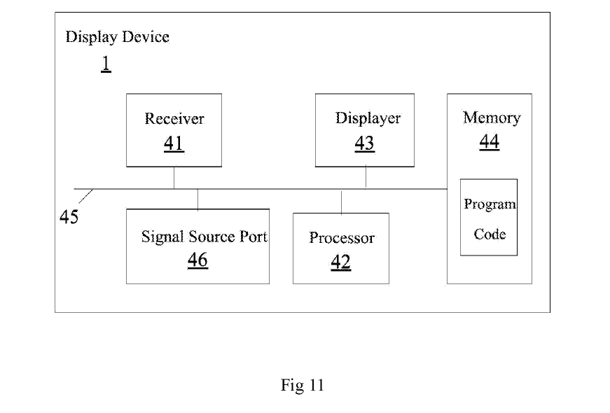

As shown in FIG. 11, the embodiment of the present application provides a display device which corresponds to the display method provided by the second and fourth embodiments of the present application, wherein the display device may include a receiver 41, a processor 42, a display 43, a memory 44, a system bus 45 and a signal source port 46, wherein:

The receiver 41, the processor 42, the display 43, the memory 44 and the signal source port 46 are connected through the system bus 45and the mutual communications are completed.

The processor 42 may be a single-core or multi-core central processing module, or a specific integrated circuit, or be configured into one or more integrated circuits that implement the embodiment of the present application.

The memory 44 may be a high speed RAM, or a non-volatile memory, for example, at least one magnetic disc memory.

The memory 44 is used for a computer executable instruction. To be specific, the computer executable instruction may include a program code.

To be specific, the processor 42 may be used to respectively acquire a data signal received by each signal source port through the system bus 45; the display 43 may be used to preset a plurality of preview windows on a desktop, each preview window corresponding to one signal source port, and display a data signal received by a corresponding signal source port in each preview window through the acquisition module at the same time through the system bus 45; and the memory 44 may be used to store the software code of the data signal received by the signal source port 46 and the software program controlling the display device to complete the foregoing process, so that the processor 42 may complete the foregoing process through executing the software program stored in the memory 44 and calling in the corresponding software code.

Optionally, the processor 42 is used to input the data signal received by each signal source port to the player corresponding to each signal source port to play; and the display 43 is used to display the playing image of the corresponding player in each preview window through the graphic program interface corresponding to the corresponding signal source port.

Optionally, the processor 42 is used to configure a player and a graphic program interface corresponding to each signal source port so as to play the data signal received by each signal source port.

Optionally, the processor 42 is used to create a player and a graphic program interface corresponding to each signal source port, and associate the player and the graphic program interface corresponding to the same signal source port, so as to display a playing image of the player corresponding to the same signal source port through the graphic program interface corresponding to the same signal source port.

Optionally, the processor 42 is used to read locally pre-stored position data and dimension data in the attribute information of each preview window; and for the player, the graphic program interface and the preview window corresponding to the same signal source port, the processor 42 sets the graphic program interface in the position of the corresponding preview window, and controls the dimension of the playing image of the player to be matched with the dimension of the preview window through the graphic program interface.

Optionally, the processor 42 is used to acquire audio and video parameters of a data signal received by each signal source port, and configure the player corresponding to each signal source port according to the audio and video parameters of the data signal received by each signal source port.

Optionally, the receiver 41 is used to receive a triggering instruction from the control device on the signal source port; and the processor 42 is used to, when the receiver 41 receives the triggering instruction, keep receiving the data signal of the triggered signal source port, and call in a full screen dimension, control to amplify the dimension of a playing image of the player of the triggered signal source port to be matched with the full screen dimension through the graphic program interface of the triggered signal source port; and log off a player and a graphic program interface corresponding to an untriggered signal source port to release the occupied resources.

According to the display device provided by the embodiment of the present application, when the user enables a signal source desktop, the data signals received by each signal source port of the display device may be displayed in each preview window respectively corresponding to each signal source port at the same time, i.e., the data signals received by each signal source port are displayed in a preview manner at the same time; therefore, the user can intuitively and clearly know the data signals received by each signal source port, thus being capable of improving the display effect, facilitating the user operation and improving the user experience.

Those skilled in the art may clearly understand that, to describe conveniently and simply, it is only illustrated by taking the division of each functional module above as an example for the purpose of convenient and simple description. In practical application, the foregoing function distribution may be finished by different functional modules according to requirements. That is, the interior of the apparatus is divided into different functional modules so as to finish all or part of the functions described above. For specific working processes of the device described above, reference may be made to corresponding processes in the foregoing method embodiments, which will not be elaborated herein.

In several embodiments of the present application, it should be understood that the disclosed device, and method may be implemented in other ways. For example, the device embodiments described in the following are only exemplary.

The modules described may or may not be physically separated from each other, and the parts shown as modules may be one or more physical modules, that is, the parts may be located at the same place, and may also be distributed to multiple different places. A part or all of the modules may be selected according to an actual requirement to achieve the objectives of the solutions in the embodiments.

In addition, function modules in the embodiments of the present application may be integrated into a processing module, or each module exists singly and physically, or two or more modules are integrated in one module. The foregoing integrated module may either be fulfilled using a hardware form, or be fulfilled using a software function module form.

If the integrated module is implemented in the form of a software function module and is sold or used as an independent product, it may be stored in a readable storage medium. Based on such understanding, the technical solutions of the present application essentially, or the part contributing to the prior art, or all or a part of the technical solutions may be implemented in the form of a software product. The software product is stored in a storage medium and includes several instructions for instructing a device (which may be a singlechip, a chip and so on) or a processor to execute all or a part of steps of the methods described in the embodiments of the present application. While the abovementioned storage medium includes: any medium that is capable of storing program codes, such as a USB disk, a mobile hard disk drive, a read-only memory (ROM), a random access memory (RAM), a magnetic disk, or an optical disk.

The above description is merely detailed implementation manner of the present application, but not intended to limit the protection scope of the present application. Any changes or replacements easily figured out by those skilled in the art without departing from the technical scope disclosed by the present application shall all fall within the protection scope of the present application. Therefore, the protection scope of the present application shall be subjected to the protection scope of the claims.

### Ninth Embodiment

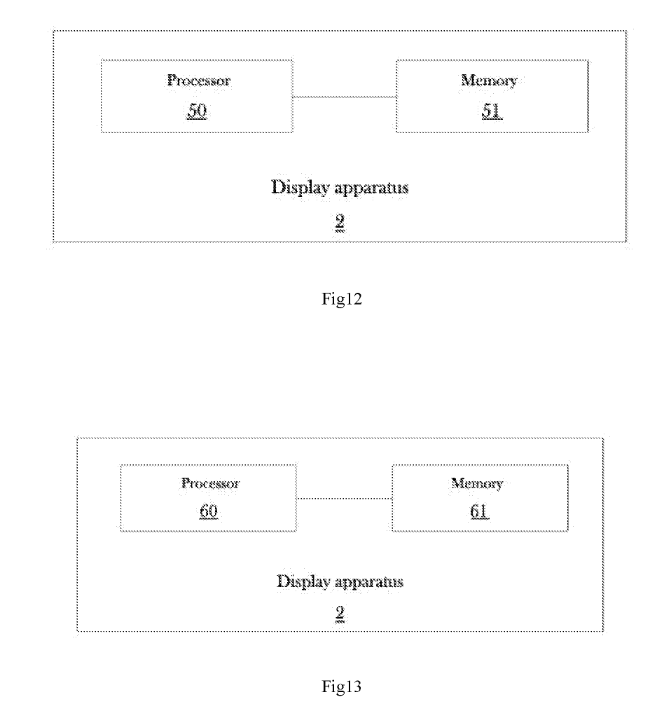

Corresponding to FIG. 12, the embodiment of the disclosure further includes another display apparatus. The apparatus 2 includes:

a processor 50; and

an memory 51 for storing commands executed by the processor 50;

wherein the processor 50 is configured to:

when displaying a first data signal received by a current signal source port in a current preview window corresponding to the current signal source port, receiving a switching instruction from a control device, the switching instruction being used to instruct to switch from the current signal source port to a first signal source port;

acquiring a second data signal received by the first signal source port according to the switching instruction; and

displaying the second data signal in the position of a first preview window corresponding to the first signal source port.

In one embodiment, the processor 50 is further configured to:

configuring a first player and a first graphic program interface corresponding to the first signal source port to play the second data signal.

In one embodiment, the processor 50 is further configured to:

creating the first player and the first graphic program interface corresponding to the first signal source port, and associating the first player with the first graphic program interface so as to display a playing image of the first player through the first graphic program interface.

In one embodiment, the processor 50 is further configured to:

logging off a current player and current graphic program interface corresponding to the current signal source port, and releasing resources occupied by the current player and the current graphic program interface so as to use the resources when creating the first player and first graphic program interface corresponding to the first signal source port.

In one embodiment, the processor 50 is further configured to:

reading locally pre-stored position data and dimension data in attribute information of the first preview window, setting the first graphic program interface corresponding to the first signal source port in the position of the first preview window, and controlling the dimension of a playing image of the first player corresponding to the first signal source port to be matched with the dimension of the first preview window through the first graphic program interface.

In one embodiment, the processor 50 further configured to:

parsing to acquire audio and video parameters of the second data signal, and configuring the first player corresponding to the first signal source port according to the audio and video parameters of the second data signal.

In one embodiment, the processor 50 is further configured to:

inputting the second data signal to the first player corresponding to the first signal source port to play; and

displaying a playing image of the first player in the first preview window through the first graphic program interface corresponding to the first signal source port.

In one embodiment, the processor 50 is further configured to:

receiving a full screen playing instruction from the control device, calling in a full screen dimension, and controlling to amplify the dimension of the playing image of the first player to be matched with the full screen dimension through the first graphic program interface.

In one embodiment, the processor 50 is further configured to:

when receiving the switching instruction from the control device, intercepting a last frame static image of the first data signal received by the current signal source port, and displaying the last frame static image of the first data signal in the current preview window.

### Tenth Embodiment

Corresponding to FIG. 13, the embodiment of the disclosure further includes another display apparatus. The apparatus 2 includes:

a processor 60; and

an memory 61 for storing commands executed by the processor;

wherein the processor 60 is configured to:

presetting a plurality of preview windows on a desktop, each preview window corresponding to one signal source port; and

receiving an enabled instruction from a control device, respectively acquiring a data signal received by each signal source port, and displaying a data signal received by a corresponding signal source port in each preview window.

In one embodiment, the processor 60 is further configured to:

configuring a player and a graphic program interface corresponding to each signal source port so as to play the data signal received by each signal source port.

In one embodiment, the processor 60 is further configured to:

creating a player and graphic program interface corresponding to each signal source port, and associating the player and graphic program interface corresponding to the same signal source port, so as to display a playing image of the player corresponding to the same signal source port through the graphic program interface corresponding to the same signal source port.

In one embodiment, the processor 60 is further configured to:

reading locally pre-stored position data and dimension data in attribute information of each preview window; and

for the player, the graphic program interface and the preview window corresponding to the same signal source port, setting the graphic program interface in the position of the corresponding preview window, and controlling the dimension of playing image of the player to be matched with the dimension of the preview window through the graphic program interface.

In one embodiment, the processor is further configured to:

parsing to acquire audio and video parameters of a data signal received by each signal source port, and configuring a player corresponding to each signal source port according to the audio and video parameters of the data signal received by each signal source port.

In one embodiment, the processor 60 is further configured to:

inputting the data signal received by each signal source port to a player corresponding to each signal source port to play; and

displaying a playing image of a corresponding player in each preview window through a graphic program interface corresponding to a corresponding signal source port.

In one embodiment, the processor is further configured to:

receiving a triggering instruction from the control device for the signal source port, keeping receiving a data signal of the triggered signal source port, and calling in a full screen dimension;

controlling to amplify the dimension of a playing image of a player of the triggered signal source port to be matched with the full screen dimension through a graphic program interface of the triggered signal source port; and

logging off a player and a graphic program interface corresponding to an untriggered signal source port to release occupied resources.

### INDUSTRIAL APPLICABILITY

According to the display method and the display device provided by the embodiment of the present application, when the user switches a signal source, the display device may display the data signal received by the switched signal source port in the preview window corresponding to the signal source port, which namely displays the data signal received by the switched signal source port in a preview manner; therefore, the user can intuitively and clearly know the data signal received by the signal source port.

Moreover, when the user enables a signal source desktop, the data signals received by various signal source ports of the display device may be displayed in various preview windows respectively corresponding to various signal source ports at the same time, i.e., the data signals received by various signal source ports are displayed in a preview manner at the same time; therefore, the user can intuitively and clearly know the data signals received by various signal source ports.

1. A display method, comprising:
when displaying a first data signal received by a current signal source port in a current preview window corresponding to the current signal source port, receiving a switching instruction from a control device, the switching instruction being used to instruct to switch from the current signal source port to a first signal source port;
acquiring a second data signal received by the first signal source port according to the switching instruction; and
displaying the second data signal in the position of a first preview window corresponding to the first signal source port.

2. The display method according to claim 1, wherein, acquiring the second data signal received by the first signal source port according to the switching instruction further comprises:
configuring a first player and a first graphic program interface corresponding to the first signal source port to play the second data signal.

3. The display method according to claim 1, wherein, configuring the first player and first graphic program interface corresponding to the first signal source port further comprises:
creating the first player and the first graphic program interface corresponding to the first signal source port, and associating the first player with the first graphic program interface so as to display a playing image of the first player through the first graphic program interface.

4. The display method according to claim 1, wherein, configuring the first player and the first graphic program interface corresponding to the first signal source port further comprises:
logging off a current player and current graphic program interface corresponding to the current signal source port, and releasing resources occupied by the current player and the current graphic program interface so as to use the resources when creating the first player and first graphic program interface corresponding to the first signal source port.

5. The display method according to claim 1, wherein, configuring the first player and first graphic program interface corresponding to the first signal source port further comprises:
reading locally pre-stored position data and dimension data in attribute information of the first preview window, setting the first graphic program interface corresponding to the first signal source port in the position of the first preview window, and controlling the dimension of a playing image of the first player corresponding to the first signal source port to be matched with the dimension of the first preview window through the first graphic program interface.

6. The display method according to claim 1, wherein, configuring the first player and the first graphic program interface corresponding to the first signal source port further comprises:
parsing to acquire audio and video parameters of the second data signal, and configuring the first player corresponding to the first signal source port according to the audio and video parameters of the second data signal.

7. The display method according to claim 1, wherein, displaying the second data signal in the position of the first preview window corresponding to the first signal source port further comprises:
inputting the second data signal to the first player corresponding to the first signal source port to play; and
displaying a playing image of the first player in the first preview window through the first graphic program interface corresponding to the first signal source port.

8. The display method according to claim 7, wherein, the method, after displaying the second data signal in the position of the first preview window corresponding to the first signal source port, further comprises:
receiving a full screen playing instruction from the control device, calling in a full screen dimension, and controlling to amplify the dimension of the playing image of the first player to be matched with the full screen dimension through the first graphic program interface.

9. The display method according to claim 7, wherein, the method, after displaying the second data signal in the position of the first preview window corresponding to the first signal source port, further comprises:
when receiving the switching instruction from the control device, intercepting a last frame static image of the first data signal received by the current signal source port, and displaying the last frame static image of the first data signal in the current preview window.

10. A display method, comprising:
presetting a plurality of preview windows on a desktop, each preview window corresponding to one signal source port; and
receiving an enabled instruction from a control device, respectively acquiring a data signal received by each signal source port, and displaying a data signal received by a corresponding signal source port in each preview window.

11. The display method according to claim 10, wherein, the method, after receiving the enabled instruction from the control device, and respectively acquiring the data signal received by each signal source port, further comprises:
configuring a player and a graphic program interface corresponding to each signal source port so as to play the data signal received by each signal source port.

12. The display method according to claim 10, wherein, configuring the player and graphic program interface corresponding to each signal source port further comprises:
creating a player and graphic program interface corresponding to each signal source port, and associating the player and graphic program interface corresponding to the same signal source port, so as to display a playing image of the player corresponding to the same signal source port through the graphic program interface corresponding to the same signal source port.

13. The display method according to claim 10, wherein, configuring the player and graphic program interface corresponding to each signal source port further comprises:
reading locally pre-stored position data and dimension data in attribute information of each preview window; and
for the player, the graphic program interface and the preview window corresponding to the same signal source port, setting the graphic program interface in the position of the corresponding preview window, and controlling the dimension of playing image of the player to be matched with the dimension of the preview window through the graphic program interface.

14. The display method according to claim 10, wherein, configuring the player and the graphic program interface corresponding to each signal source port further comprises:
parsing to acquire audio and video parameters of a data signal received by each signal source port, and configuring a player corresponding to each signal source port according to the audio and video parameters of the data signal received by each signal source port.

15. The display method according to claim 10, wherein, displaying the data signal received by the corresponding signal source port in each preview window further comprises:
inputting the data signal received by each signal source port to a player corresponding to each signal source port to play; and
displaying a playing image of a corresponding player in each preview window through a graphic program interface corresponding to a corresponding signal source port.

16. The display method according to claim 15, wherein, the method, after displaying the data signal received by the corresponding signal source port in each preview window, further comprises:
receiving a triggering instruction from the control device for the signal source port, keeping receiving a data signal of the triggered signal source port, and calling in a full screen dimension;
controlling to amplify the dimension of a playing image of a player of the triggered signal source port to be matched with the full screen dimension through a graphic program interface of the triggered signal source port; and
logging off a player and a graphic program interface corresponding to an untriggered signal source port to release occupied resources.

17-32. (canceled)

33. A display apparatus, comprising
a processor; and
an memory for storing commands executed by the processor;
wherein the processor is configured to:
when displaying a first data signal received by a current signal source port in a current preview window corresponding to the current signal source port, receiving a switching instruction from a control device, the switching instruction being used to instruct to switch from the current signal source port to a first signal source port;
acquiring a second data signal received by the first signal source port according to the switching instruction; and
displaying the second data signal in the position of a first preview window corresponding to the first signal source port.
